(19) United States
(12) Patent Application Publication
(10) Pub. No.: US 2007/0033887 A1
(43) Pub. Date: Feb. 15, 2007

(54) System for alleviating in-vault condensation in double-glazed windows

(76) Inventor: David Howard Ambrose, King City (CA)

Correspondence Address: ANTHONY ASQUITH, 28-461 COLUMBIA STREET WEST, WATERLOO, ON, N2T 2P5, CA

(21) Appl. No.: 10/572,850

(22) PCT Filed: Sep. 27, 2004
(86) PCT No.: PCT/CA04/01673

§ 371 Date: Mar. 22, 2006

(30) Foreign Application Priority Data
Sep. 26, 2003 (GB) 0322606.5
Nov. 20, 2003 (GB) 0327038.6

(51) Int. Cl. E06B 7/00

(52) U.S. Cl. 52/171.3

(57) ABSTRACT

A hole is drilled through from the outside atmosphere into the between-panes vault, and into the hole is inserted a normally-open valve assembly. The valve Is arranged to close responsively to the presence of a pressure differential in such direction that air would tends to enter the vault.

In a double-glazed window, two glass panes are held apart by, and sealed to, a spacer, defining a sealed vault between the panes. It is a well-known problem with double-glazed windows that condensation can appear on the inside-facing surfaces of the panes. Apart from visibly clouding the glass, the condensation can cause minerals to leach out of the glass, which, over a period of months or years, can damage the surface of the glass, with the result that, even if the moisture is then removed, some of the cloudiness remains. Another consequence is that the heat-insulative effect of a window having condensed moisture in its between-panes vault can be much less than that of a window in which the vault is dry.

The moisture enters through minute cracks and fissures that develop at the interface between the sealant/adhesive and the glass. (And also, water can in fact simply diffuse in through most sealant materials, even if there are no identifiable fissures, over a long period.)

Glass is a notoriously difficult material for adhesives to adhere to. For a window that is e.g two metres square, the total sealed length is thirty-two metres; It is asking a good deal of the adhesive/sealant to expect that there would be no hairline leaks, ever, over such a length, even though the windows are produced under factory-controlled conditions.

Measures taken to delay the onset of in-vault condensation have included very careful and meticulous preparation of the surfaces to be sealed, the provision of desiccant in a retaining cavity in the spacer, etc. The problem is that, over the years, the tiny fissures and microcracks do indeed develop between the sealant/adhesive and the glass. Moisture starts to work its way through the crack by capillary action, driven by the humidity gradient. At first, all the moisture that gets through can be absorbed into the desiccant. But eventually, the desiccant becomes saturated, and then the moisture condenses on the glass surfaces. Even though every care and precaution may be taken during manufacture of the window, still it is all too common for condensation to appear.

### THE INVENTION IN RELATION TO THE PRIOR ART

The invention is aimed at providing a cost-effective system for remediating a double-glazed window in which the problem of in-vault condensation has started to manifest itself. The system may also be used for prevention; especially in a case where condensation has appeared in one of a set of windows installed at the same time, it may be prudent to apply the system in the other windows as well.

When condensation has been encountered, various remediation measures have been suggested and tried. These have included such measures as drilling a hole in one or both of the panes of glass to enable (humid) air to escape from the between-panes vault. Various techniques for removing the liquid condensate from the inside surfaces have also been developed.

An example of a previous attempt at remediation is shown in patent publication CA-1,332,541.

### GENERAL FEATURES OF THE INVENTION

In the invention, it is preferred to insert a valve assembly through a through-hole in one of the panes, preferably the outside pane. The valve assembly preferably is operable between a closed condition, in which the closure member makes sealing contact with the seating, whereby air cannot pass between the vault and the air outside the first pane, and an open condition, in which the closure member is out of sealing contact with the seating, whereby air can pass between the vault and the air outside the first pane. Preferably, the valve assembly includes an operator, which is effective to operate the valve between the closed condition and the open condition. Preferably, the operator is effective to operate the valve in response to a change in the pressure differential between the air in the vault and the air outside the first pane.

### DETAILED DESCRIPTION OF PREFERRED EMBODIMENTS

By way of further explanation of the invention, exemplary embodiments of the invention will now be described with reference to the accompanying drawings, in which,

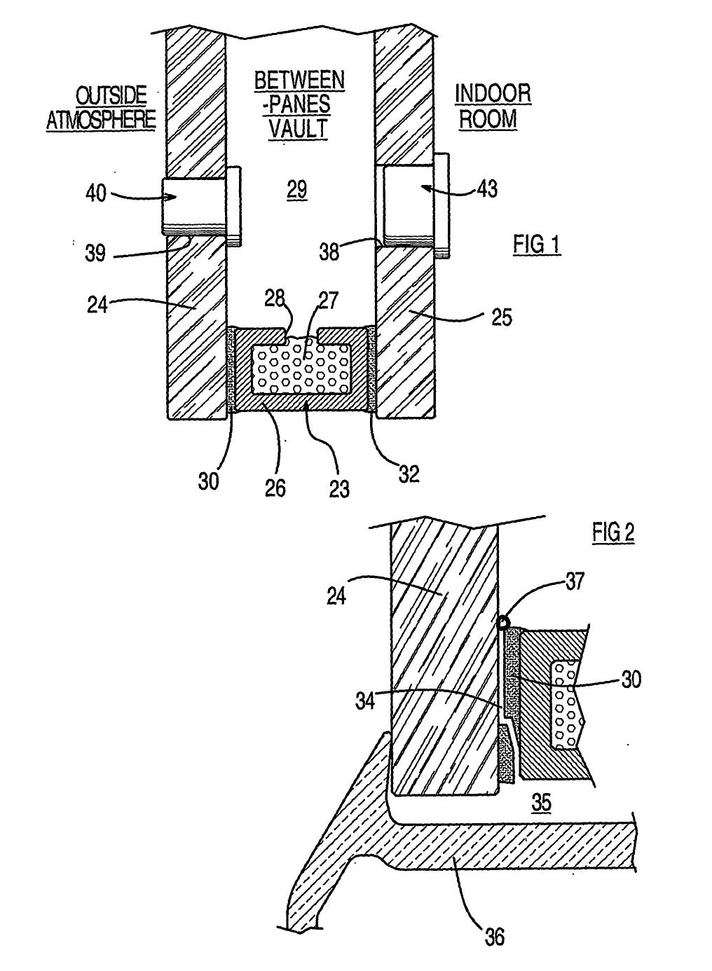

FIG. 1 is a cross-sectioned side elevation of the lower area of a double-glazed window, in which holes have been drilled in preparation for alleviation of condensation from the between-panes vault;

FIG. 2 is a closeup of an area of FIG. 1, showing the manner of ingress of water into the between-panes vault;

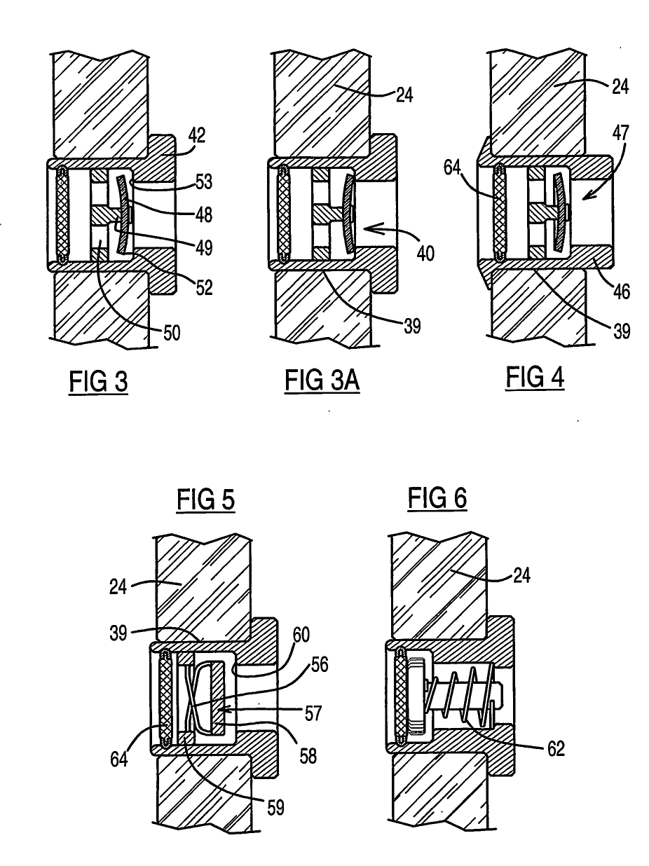

FIG. 3 is the same view as FIG. 1, but includes, in the drilled holes, components of an apparatus that embodies the invention;

FIG. 3a is the same view as FIG. 3, but shows the apparatus in a closed condition,

FIG. 4 is a view like FIG. 3 of another embodiment;

FIG. 5 is a view like FIG. 3 of another embodiment;

FIG. 6 is a view like FIG. 3 of another embodiment.

The apparatuses shown in the accompanying drawings and described below are examples which embody the invention. It should be noted that the scope of the invention is defined by the accompanying claims, and not necessarily by specific features of exemplary embodiments.

FIG. 1 shows a double-glazed window 20, comprising two panes of glass held apart by a spacer 23. The window 20 is a window in a building, and is arranged such that the left pane 24 faces the outside atmosphere, and the right pane 25 faces inside a room of the building.

The spacer 23 comprises an extrusion 26 of aluminum or plastic (or a composite) and includes a cavity. Contained within the cavity is a quantity 27 of desiccant material. Slots 28 in the extrusion 26 provide air communication between the desiccant and the air in the between-panes vault 29, being the airspace between the panes 24,25 bounded by the spacer 23 which extends all around a periphery or circumference of the vault 29.

The spacer 23 is secured between the panes of glass by means of sealant/adhesive 30,32. FIG. 2 is a close-up of the apparatus including the sealant 30. In this case, a micro-crack 34 has developed between the sealant and the inner surface of the pane 24. The crack 34 extends all the way from the between-panes vault 29 into the under-airspace 35 under the window 20, i.e the airspace between the window frame 36 and the window 20 itself.

This under-airspace 35 may be expected to be at least at a relatively high level of humidity, if not actually wet. Rainwater sheeting down the outside of the left pane 24 is deflected away by the frame 36, but inevitably some moisture will collect in the under-airspace 35. Thus, the lower end of the crack 34 is at a higher humidity than the air in the between-panes vault 29. It can be expected that, over a period of time, moisture will work its way up the crack 34—driven by the humidity gradients and by capillary action—whereby, eventually, an actual droplet 37 of water will collect at the top end of the crack. (The high-humidity space from which water might enter the vault need not be underneath.)

So long as the droplet stays there, not much harm will be done. However, the vault 29 is sealed, and the consequence of the vault being sealed will now be considered. When the window is subjected to direct sunlight during the day, the warm air inside the vault expands. At night, the air in the vault cools and contracts. It can happen that the volume of the air inside the sealed vault 29 changes by as much as ten percent between night and day. In a typical sealed window installation, the panes 24,25 can move towards and away from each other, on a day/night cycle, as much as a millimetre—more, in some cases.

The vault 29 being sealed, the air pressure inside the vault changes in more or less the same ratio as the change in volume. Thus, the pressure in the sealed vault can be 100 millibars (=ten kPa) less at night than during the day. This large reduction in pressure is repeated on a daily cycle, and eventually the droplet 37 is sucked up into the vault 29 (and a new droplet starts to form at the top end of the crack). After that, the moisture vapour from the droplet finds its way into the desiccant 27. Over a period of years, the desiccant becomes saturated with water. Then, after that, the humidity level of the air sealed into the vault starts to rise, until condensation manifests itself on the inside surfaces of the panes 24,25.

To remediate the window 20, operators first drill a through-hole 38 through the inside pane 25 (FIG. 1) from inside the room. Then, by the use of such measures as may be judged efficacious, the film of condensation is removed from the inside surfaces. Typically, this will involve inserting a cleansing liquid into the between-panes vault 29 through the hole 38. The cleansing liquid, and the collected condensation, is drained out of the vault, again through the hole 38. When that has been completed to the operators' satisfaction, a supply of pre-dried air is directed in through the hole 38, to remove all final traces of the moisture and liquids. Preferably, this air is pre-dried by passing the air over or through a body of desiccant material. The pre-dried air preferably should be dried to the extent that its dewpoint is at least twenty centigrade degrees below the dewpoint of the air outside the vault.

(Blowing the dried air through the between-panes vault removes the traces of liquid condensate and cleansing liquid, but does not remove any of the absorbed water from the desiccant. The desiccant material is highly hygroscopic and hydrophillic, and was selected for its ability to attract and retain water; once water has been absorbed into the material, it is not possible to get it out—at least not by any commercially practical method that can be performed in-situ—nor even to reduce the level of saturation to any significant extent.)

The operators may prefer to drill another hole (not shown) through the inside pane 25, to facilitate the flushing through of the cleansing liquid and/or the dried air into and through the vault 29.

The operators now drill a through-hole 39 through the left or outside pane 24. (It may be more convenient to drill the outside through-hole 39 through the outside pane 25 prior to cleansing the vault, rather than after cleansing.) The outside through-hole 39 is aligned with the inside through-hole 38, whereby the outside hole 39 can be drilled from inside the room.

The operators now insert the valve assembly 40 (FIG. 3) into the prepared hole 39 in the outside pane 24. The valve housing 42 should be a mechanically tight (and airtight) fit in the hole 39, and preferably the housing is held in place in the hole 39 with adhesive/sealant. With the valve assembly secure, the operators complete the job by inserting an airtight plug 43 into the hole 38 in the inside pane 25, and again the plug 43 should be held in place with adhesive/sealant.

If the operators made other holes through the panes in order to facilitate the clean-up operation, each hole in the inside pane 26 should be sealed by an airtight plug; and each hole in the outside pane 24 should either contain a valve assembly or be sealed by an airtight plug.

The operators may elect to make the holes from outside the window, if that is accessible. In that case (FIG. 4), the hole 39 in the outside pane 24 is made directly, and preferably no holes at all are made in the inside pane 25. To be suitable for outside insertion, the housing 46 is shaped rather differently from the housing 42 in FIG. 3, but otherwise the valve assembly 47 is the same as valve assembly 40.

A shown in the drawings, the through-holes into the vault are made by drilling holes in the glass panes. If access is so available, in a particular case, some or all of the holes may alternatively be made in the spacer, rather than in the panes.

The valve assembly 40 of FIG. 3 includes a closure member in the form of a domed diaphragm 48. This is mounted on the stem 49 of a spider 60. The domed diaphragm 48 is made of resilient elastomeric material, and its natural or normal shape is as shown in FIG. 3. In FIG. 3, a ring 52 around the rim of the domed diaphragm remains clear of the seating 63 formed in the housing 42, and hence air can pass freely through the valve assembly, and through the hole 39 in the outside pane 25, whereby air can freely enter into (exit from) the between-panes vault 29 from (to) the outside atmosphere.

If air is blowing in a direction from the left in FIG. 3, towards the window, a dynamic pressure differential can develop between the left and right sides of the domed diaphragm 48. The resulting force on the diaphragm can cause it to flip inside out, whereby the diaphragm takes up the inverted shape as shown in FIG. 3a. Now, the ring 52 is in contact with the seating 53, and air can no longer pass through into the vault. But then, as soon as the pressure differential disappears, the domed diaphragm 48 flips back to its FIG. 3 condition, and the valve is once more able to freely transmit air between the between-panes vault and the outside atmosphere.

Thus, the valve assembly 40 is of a normally-open configuration. That is to say, a threshold of force from the left is required in order to make the closure member, i.e the domed diaphragm 48, move to the right and to close against the seating 53. Otherwise, the valve remains open.

One of the functions of the valve assembly is to ensure that actual physical drops of liquid water cannot enter the between-panes vault. Even if liquid water droplets are present at the entrance to the outside hole 39, it will be understood that water from the droplets cannot enter the vault—at least not by mechanical transport, as distinct from diffusion—unless there is a pressure differential in which the outside atmospheric pressure is greater than the pressure of the air inside the vault, whereby air in the vicinity of the droplets would have a velocity vector directed inwards towards the vault

It is recognised, in the invention, that the tiny traces of water vapour that enter the vault by diffusion are of little significance from the standpoint of preventing togging (or rather, of delaying the onset of fogging). It is recognised that the gross amounts of water that would enter the vault if entry in the form of actual liquid drops were permitted, would be highly significant.

In fact, it may be expected that even if a stream of water were jetted against the window, e.g for window-cleaning purposes, the valve would close if the water attempted to enter, through the valve, into the vault. (Of course, this is not guaranteed: it might be possible for a person to beat the valve, by aiming a high-pressure jet of water obliquely at the valve.)

Heavy rain precipitation can cause water to sheet down the outside surface of the window 20. But so long as the valve assembly is shaped to prevent water descending under gravity from being actually directed into the valve, that water will not enter unless there is a pressure differential. Heavy rain driving against the window pane 24 of course does provide such a pressure differential, but then the pressure differential is effective to close the valve.

A cleaning jet of water would be treated the same way. Windows may also be washed by a squeegee or washcloth; but again, it is to be expected that water droplets cannot enter the vault unless there is a pressure differential, but then they cannot enter the vault because the pressure differential closes the valve.

FIG. 5 shows another way of arranging the valve assembly. Here, the resilient spring function is provided by springy arms 56. The arms 56 are moulded into a plastic component 57 that also includes a closure member 58 and a mounting ring 69. The unstressed condition is shown in FIG. 4; if there is a higher pressure to the left, the closure member 58 moves to the right, and closes against the seating 60.

FIG. 6 shows another valve arrangement. Here, the resilient spring function is provided by a coil spring 62 made of stainless steel wire.

Although the designs shown in FIG. 5 and FIG. 6 can be effective, the domed diaphragm 48 of FIG. 3 is preferred because of its snap action. That is to say, the diaphragm snaps rapidly from fully open to fully closed, and then snaps back from fully closed to fully open. The valve closure member spends almost no time in an almost-closed condition. This is advantageous in sharply defining the pressure at which closure takes place.

It is important that the closure does not tale place at too low a pressure differential, because the valve should be wide open at zero pressure differential, to enable full pressure equalisation to take place between the vault and the outside air. However, given that the valve should be wide open at zero pressure differential, the designer wishes the valve to be fully closed at a very small increment of pressure differential above zero, so as to bar any water from entering the vault. The higher the pressure differential at which the valve closes, in the direction tending to drive air into the vault, the greater the opportunity for moisture to enter the vault. The snap action, which arises from the domed diaphragm design, enables the designer to arrange that the valve is wide open at zero pressure differential, and yet is fully closed at only a very small pressure differential above zero.

As shown, it is preferred to include a filter screen 64 in order to prevent dirt particles, small insects, etc from entering the valve assembly, and perhaps clogging the moving parts. The valve is set to operate at a very small pressure differential, whereby it would not take much in the way of dirt or other inclusions to affect its operation. The filter screen should include a mesh having a pitch that is preferably not coarser than about fifty by fifty holes per inch mesh size. A filter screen of this fineness reflects the fact that the valve assembly is set to operate at a low pressure, and is thus of a delicate construction, whereby the operation of the valve might be vulnerable if larger inclusions were permitted. The filter screen should be positioned on the open atmosphere side of the valve assembly—where the dirt comes from.

The pressure at which the valve operates will now be considered.

In the case of a hermetically sealed vault, the air pressure in the between-panes vault can change. The variation in pressure arises mainly in accordance with variations in temperature. The temperature of the air inside the vault also drops, with the result that the pressure of the air inside the vault can drop e.g several pascals and indeed several millibars (hundred Pa=one millibar). Such changes can take place very rapidly, i.e within a few seconds—where the window has been exposed to sunlight, and then becomes suddenly shaded, or is suddenly rained on. Even greater changes in temperature (and pressure) can occur between e.g day and night.

Also, the volume of the vault can change due to flexure of the glass, for example when a truck drives by the building, and this too gives rise to changes in air pressure inside a sealed vault.

As mentioned, when the between-panes vault is hermetically sealed, it is possible for the inner and outer panes to cycle through a distance of a millimetre (or even more) on a day/night cycle. This represents a change in pressure of, possibly, plus/minus a hundred millibars (=ten kPa) or so of the volume of air sealed into the between-panes vault. Now, the atmospheric pressure in the air outside the building (and in the room inside the building) varies much less than this. Normal atmospheric pressure varies by not much more than plus/minus ten millibars. This is to be contrasted with the pressure differential that might exist, at night, between a sealed vault and the outside air, which could be an order of magnitude greater.

This huge pressure differential is added to the effects of capillary action, diffusion, humidity gradients, etc, in driving the moisture into and along the crack 34. More importantly, the huge pressure differential can be instrumental in causing the droplet 37, once formed, to be sucked up into the vault.

When the vault is not sealed, i.e when there is a through-hole through the pane, between the vault and the outside air, the ability of the pressure differential to build up is limited by the size of the hole, if the hole is large, no pressure differential can exist. The smaller the hole, the longer it takes for the pressure differential to be negated; and also, the larger the pressure differential, the longer it takes for it to be equalised through a small hole.

It is recognised that the cross-sectional area of the outside through-hole 39 should be large. That is to say, the hole 39 should be large enough that air can pass from the outside atmosphere into the between-panes vault rapidly enough that no significant pressure differential can ever build up. In this context, a significant pressure differential would be of the order of five pascals or more. The hole 39 should be large enough that air can move through the hole 39 rapidly enough to eliminate any pressure differential that might tend to occur, more or less immediately.

Again, in the case of a sealed vault, the pressure differentials that can occur can be very significant. If the outside pane had a very small through-hole, any pressure differential that tended to be built up over several hours would not be a problem, because several hours is long enough for the pressures to equalise, even through a very small hole. But, if the pressure differential were to build up over a period of just a few seconds, now the size of the hole does indeed make a difference. A very small hole would be much less effective is equalising (i.e negating) a rapid change in pressure differential than a large hole. That is to say, it the hole is very small, and it the pressure differential is applied rapidly, a large pressure differential might still build up between the between-panes vault and the outside atmosphere, and the large pressure differential, even it were maintained for only a few seconds, would make it more likely that the droplet 37 of water might be sucked up into the between-panes vault.

It the hole is large enough, however, air can transfer between the atmosphere and the vault (or vice versa) rapidly enough that no pressure differential can ever build up, even for a few seconds. It is recognised that it can become difficult to engineer a valve assembly of air through-flow dimensions that would be regarded as adequate from this standpoint, if the through-hole in the glass is less than about five mm diameter.

On the other hand, of course, the through-hole should not be too large, or it would become impractical to engineer a valve assembly that was inexpensive and at the same time operationally effective to seal the hole. The through-hole in the glass should not be larger than about twenty mm diameter from this standpoint.

Just one hole, and one valve assembly, of a six or seven mm through-hole size, may be expected to be adequate for a window up to about two or three square metres. Above that, the hole, and the valve assembly, should be larger, or more than one through-hole and valve assembly should be provided. The valve assembly is made preferably in two sizes, for e.g a 7-mm hole and for a 12-mm hole, and that should suffice to provide convenient units for any size of double-glazed window likely to be encountered.

The force exerted by the spring, and the other physical characteristics of the valve assembly, should be such as to ensure that the valve remains open when the pressure differential is zero. However, the force should be small enough that the valve closes at only a very small differential pressure above zero. In order to ensure that the valve assembly functions substantially in the manner as described herein, the force exerted by the spring should preferably correspond to a pressure differential of more than about fifty pascals. Above that, it starts to become possible that liquid water might enter the vault. If the force from the spring were such that the valve were still not closed at a pressure differential of more than about a hundred pascals, now the chance of water entering the vault is so high that the advantages of providing the invention would more or less disappear.

It is emphasized that the force from the spring preferably should be high enough to ensure that the valve does not close when the pressure differential is zero. If it did, air could not pass freely in and out of the vault, and thus the window might behave like a sealed-vault unit, in which large pressure differentials can build up. For this reason, it is preferred that the spring be strong enough to hold the valve open until the pressure differential exceeds at least five pascals.

As shown in the drawings, the valve assembly is inserted in the outer pane, i.e the valve transfers air between the between-panes vault 29 and the outside atmosphere. The valve assembly does not transfer air between the between-panes vault 29 and the indoor room. This arrangement is suitable when the water vapour content of the outside air is greater then the water vapour content of the room air.

It is important that the vault 29 be exposed to the dryer air; generally, that is the colder air. In a hot climate (air temperature above twenty degC yearly average), though, the (air-conditioned) room air is likely to be cooler and dryer than the outside air, and in that case the valve assembly should be located so as to connect the vault with the cooler, dryer, air.

In the case of a seasonal climate, ideally the vault should be connected to the outside atmosphere in winter, and the air-conditioned room air in summer. It is notionally possible to provide two valves assemblies, one to the indoor room and the other to the outside atmosphere, and to provide a switch that closes the outside valve and opens the inside valve in April, and opens the outside valve and closes the inside valve in October. However, it is recognised that such sophistication is not essential. In the seasonal climates, in summer, the temperature difference between the outside atmosphere and the indoor room is small; whereas in winter, the temperature difference between the outside atmosphere and the indoor room is relatively much larger. Thus, if the valve is arranged to suit summer conditions, in winter the conditions will be very wrong; whereas if the valve is arranged to suit winter conditions, in summer the conditions will be slightly wrong. Therefore, the valve should preferably be arranged according to the winter setting, i.e the valve should be so placed as to connect the vault with the outside atmosphere.

Of course, double-glazing is encountered much less in hot climates than in cold. But even in the case of a hot climate, it is not always true that the air-conditioned indoor air will be dryer than the outside atmospheric air. The extra humidity in a kitchen or bathroom might tip the scales, making it better to connect the vault to the outside air after all, for the windows in those rooms. By and large, nearly all double-glazing installations in which remediation is required should have the valve assembly installed so that the air transfer path is between the vault and the outside atmosphere.

When the valve is located in the inside pane, of course there will be no driving rain to contend with; however, liquid water might still be available on the inside of the window, which could find its way in through the valve—e.g from washing sprays, and the like—and the valve assembly as described herein may be expected to be effective in preventing that water from passing into the vault.

It should be noted that the temperature of the air in the between-panes vault will be roughly halfway between the room temp and the temp outside. Thus, on a cold morning, where the outside air might have cooled below its dewpoint temperature, the same atmospheric air inside the vault will be somewhat warmer, because of the presence of the relatively warm indoor room on the other side of the window (even though the indoor room air cannot communicate with the air inside the vault). Thus, in the vault, the temperature would not drop far enough to reach the dewpoint. It may be noted that, if the room were as cold as the outside atmosphere, then, if the atmosphere reached dewpoint, the air in the vault would reach dewpoint as well.

It is an aim of the invention to ensure that the pressure of the air inside the vault cannot differ from atmospheric pressure for more than a second or two, and thus can never fall so low as to trigger the release of liquid water, into the vault, from any droplets that may have accumulated inside the vault. At the same time, it is an aim of the invention to provide an effective seal or barrier to the entry of liquid water into the vault, if an into-vault pressure differential should arise or occur at a time when liquid water might be present.

The invention may be used with a triple-glazed or multi-glazed window—noting that a triple-glazed window is a double-glazed window with an extra pane.

1. Apparatus for alleviating condensation in a double-glazed window, wherein: the apparatus includes:
two panes of glass, and a spacer structure for holding the panes apart in a parallel, spaced-apart relationship, whereby the panes define a between-panes vault;
a spacer structure, which defines a periphery or circumference of the between-panes vault;
sealing means, for sealing the panes of glass to the spacer structure, around the periphery of the vault, whereby a pressure differential can exist between the pressure of air inside the vault and the pressure of air outside the vault;
a valve assembly, which includes a closure member, a seating, and a passageway for transference of air between the vault and the air outside the vault;
the valve assembly is operable between a closed condition and an open condition;
in the open condition, the closure member is out of sealing contact with the seating, whereby the passageway is open to the transference of air between the vault and the air outside the vault;
in the closed condition, the closure member makes sealing contact with the seating, whereby air cannot pass through the passageway between the vault and the air outside the vault;
the apparatus includes a valve operator, which is effective to operate the valve between the closed condition and the open condition; and
the operator is effective to operate the valve in response to a change in the pressure differential between the air in the vault and the air outside the vault.

2. Apparatus of claim 1, wherein the passageway is so wide open, in the open condition, that any pressure differential that might be present between the air in the vault and the air outside the vault dissipates substantially instantaneously, due to transference of air into or out of the vault, through the wide-open passage.

3. Apparatus of claim 2, wherein the valve assembly lies assembled in a through-hole in one of the glass panes, and the through-hole has a diameter of not less than about five mm.

4. Apparatus of claim 3, wherein the through-hole has a diameter of not more than about twenty mm.

5. Apparatus of claim 1, wherein the valve is of a normally-open configuration, in that the valve is structured to remain in the open condition when the said pressure differential is zero or nearly zero.

6. Apparatus of claim 5, wherein the operator is effective to operate the valve to the open condition when the pressure inside the vault is higher than the pressure outside the vault.

7. Apparatus of claim 6, wherein the operator is effective to operate the valve to the closed condition when the pressure inside the vault is lower than the pressure outside the vault.

8. Apparatus of claim 7, wherein:
the valve assembly is of a normally-open check-valve configuration;
the operator includes a spring; and
the spring acts upon the closure member in such directional sense as to urge the closure member clear of the seating.

9. Apparatus of claim 8, wherein:
the spring exerts such force as to close the valve when the pressure inside the vault is lower than the pressure outside the vault, and the magnitude of the pressure differential exceeds P pascals; and
the magnitude P is more then five pascals;
whereby the valve remains open while the pressure differential is less than five pascals, and/or while the pressure inside the vault is higher than the pressure outside the vault.

10. Apparatus of claim 9, wherein the spring exerts such force that the magnitude P is less than one hundred, and preferably is less than fifty, pascals.

11. Apparatus of claim 8, wherein:
the valve assembly includes a filter screen;
the filter screen has a mesh pitch of about fifty by fifty holes per inch, or finer;
the filter screen is affixed into a housing of the valve assembly, and is so located as to prevent particles from outside the vault from reaching the spring, the closure member, and the seating.

12. Apparatus of claim 1, wherein:
the window separates a room in a building from the atmosphere outside the building;
the building is located where the average atmospheric temperature, year round, is less than twenty degC; and
the valve assembly is so oriented as to create the said passageway between the vault and the outside atmosphere.

13. Apparatus of claim 1, wherein:
the window separates a room inside a building from the atmosphere outside the building;
the building is located where the average atmospheric temperature, year round, is more than twenty degC; and
the valve assembly is so oriented as to create the said passageway between the vault and the inside room.

14. Apparatus of claim 3, wherein:
the window separates a room inside a building from the atmosphere outside the building;
the window is so oriented that one of the panes is an outside pane, being the one of the panes that is in contact with the atmosphere outside the building, and the other of the panes is an inside pane,
the through-hole in which the valve assembly lies assembled is a through-hole in the outside pane;
the inside pane is provided with an inside-pane-through-hole;
the inside-pane-through-hole is aligned with the through-hole in the outside pane to the extent that both holes can be drilled from inside the room;
the through-hole, the valve assembly, and the inside-pane-through-hole are so dimensioned that the valve-assembly can be passed through the inside-pane-through-hole, and can be inserted into the through-hole in the outside pane, from the room;
the apparatus includes an inside-pane-plug, which lies inserted into the inside-pane-through-hole,
the inside-pane-plug provides an airtight seal between the air in the vault and the air in the room.

16. Apparatus of claim 8, wherein:
the spring of the valve assembly includes a domed diaphragm, made of elastomeric material;
the closure member comprises a ring of the domed diaphragm;
the domed diaphragm is capable of flipping inside out, when subjected to a pressure differential in the direction in which pressure in the vault is lower than pressure outside the vault;
and is capable thereby of moving to a position in which the ring abuts the seating, thereby blocking air from passing into the vault.

16. Apparatus of claim 8, wherein the spring of the valve assembly includes a wire coil spring, made of a non-corroding metal.

17. Apparatus of claim 8, wherein the spring of the valve assembly includes at least one resiliently-deflectable leaf of plastic material.

18. Apparatus of claim 1, wherein the window is one in which the between-panes vault was formerly sealed alight, until the provision of the said through-hole in the glass pane, and in which desiccant material housed in the vault is saturated or almost saturated with water.

19. A procedure for remediating a double-glazed window, including:
providing the apparatus of claim 1;
then removing accumulated moisture from the between-panes vault;
then blowing pre-dried air into the vault;
where the said air has been pre-dried to the extent that its dewpoint is twenty centigrade degrees below the dewpoint of the air outside the vault.
